(19) United States
(12) Patent Application Publication
(10) Pub. No.: US 2025/0196467 A1
(43) Pub. Date: Jun. 19, 2025

(54) LAYERED ARTICLE INCLUDING SYNTHETIC POLYMER FILM HAVING ANTIMICROBIAL AND/OR ANTIVIRAL PROPERTIES, AND METHOD FOR PRODUCING THE SAME

(71) Applicant: Sharp Display Technology Corporation, Kameyama City (JP)

(72) Inventors: Hao LI, Kameyama City (JP); Tokio TAGUCHI, Kameyama City (JP); Kenichiro NAKAMATSU, Kameyama City (JP)

(21) Appl. No.: 18/956,348

(22) Filed: Nov. 22, 2024

(30) Foreign Application Priority Data
Dec. 18, 2023 (JP) 2023-212708

(51) Int. Cl. B32B 3/30; B32B 27/08; B32B 27/30; B32B 37/24; B32B 38/00

(52) U.S. Cl. CPC B32B 3/30; B32B 27/08; B32B 27/308; B32B 37/24; B32B 2038/0076; B32B 2307/714; B32B 2309/60; B32B 2310/0837

(57) ABSTRACT

A method for producing a layered article including a synthetic polymer film having antimicrobial and/or antiviral properties includes: preparing a layered article including a substrate and a synthetic polymer film formed on the substrate, wherein the synthetic polymer film has, on a surface thereof, a plurality of protrusions having area equivalent circle diameters in a range of more than 20 nm to less than 500 nm when the surface is viewed in a direction normal to the synthetic polymer film; and irradiating the plurality of protrusions in the layered article with light emitted from a xenon lamp such that the amount of irradiation with light in a wavelength range of 300 nm or more to 400 nm or less is 6 MJ/m² or more.

### BACKGROUND

### 1. Field

The present disclosure relates to a layered article including a synthetic polymer film having antimicrobial and/or antiviral properties and to a method for producing the layered article.

### 2. Description of the Related Art

The present applicant has disclosed synthetic polymer films having a moth-eye structure on their surface to allow the surface to exhibit bactericidal activity (see, for example, International Publications No. WO2015/163018, No. WO2016/080245, and No. WO2016/208540 and Japanese Unexamined Patent Application Publication No. 2019-051638, which are hereinafter referred to as PTL 1 to PTL 4). The term “synthetic polymer film” is used to distinguish it from natural products (lipid membranes) such as wings of cicadas and dragonflies having surface nanostructures. The entire disclosed contents of the above patent documents are hereby incorporated herein by reference.

It is desirable to further improve the bactericidal

activity of the synthetic polymer films. Specifically, it is desirable to improve antimicrobial properties evaluated by a method in accordance with JIS Z 2801 and/or antiviral properties evaluated by a method in accordance with ISO 21702:2019.

### SUMMARY

According to a first aspect of the disclosure, there is provided a method for producing a layered article including a synthetic polymer film having antimicrobial and/or antiviral properties, the method including:
preparing a layered article including a substrate and a synthetic polymer film formed on the substrate, wherein the synthetic polymer film has, on a surface thereof, a plurality of protrusions (which may be referred to also as “first protrusions”) having area equivalent circle diameters in a range of more than 20 nm to less than 500 nm when the surface is viewed in a direction normal to the synthetic polymer film; and
irradiating the plurality of protrusions in the layered article with light emitted from a xenon lamp such that the amount of irradiation with light in a wavelength range of 300 nm or more to 400 nm or less is 6 MJ/m² or more.

According to a second aspect of the disclosure, there is provided a layered article including a synthetic polymer film having antimicrobial and/or antiviral properties, the layered article being produced by the method for producing according to the first aspect.

### BRIEF DESCRIPTION OF THE DRAWINGS

FIG. 1A is a schematic cross-sectional view of a layered article including a synthetic polymer film having a moth-eye structure;

FIG. 1B is a schematic plan view illustrating a protrusion viewed in a direction normal to the synthetic polymer film;

FIG. 2A is a schematic cross-sectional view of a layered article including a synthetic polymer film obtained by irradiating the synthetic polymer film shown in FIG. 1A with light emitted from a xenon lamp;

FIG. 2B is a schematic plan view showing a protrusion viewed in a direction normal to the synthetic polymer film;

FIG. 3 shows an SEM image of a surface of a synthetic polymer film having a moth-eye structure;

FIG. 4 shows an SEM image of a surface of a synthetic polymer film obtained by irradiating the synthetic polymer film having the moth-eye structure shown in FIG. 3 with light emitted from a xenon lamp;

FIG. 5 is a graph showing the change in pH over time with and without xenon lamp irradiation;

FIG. 6 is a graph showing the change in antimicrobial properties with xenon lamp irradiation;

FIG. 7 is a graph showing the change in antiviral properties (the amount of influenza virus A) with xenon lamp irradiation;

FIG. 8 is a graph showing the change in antiviral properties (the amount of feline calicivirus) with xenon lamp irradiation; and

FIG. 9 is an illustration showing the autoxidation mechanism of a synthetic polymer.

### DESCRIPTION OF THE EMBODIMENT

Referring next to the drawings, a description will be given of a layered article in an embodiment of the present disclosure that includes a synthetic polymer film having antimicrobial and/or antiviral properties and a method for producing the layered article. However, the layered article in the embodiment of the present disclosure that includes the synthetic polymer film having antimicrobial and/or antiviral properties and the method for producing the layered article are not limited to the following examples. The phrase “having antimicrobial properties” means that an antimicrobial activity value obtained by a test method in accordance with JIS Z 2801 is 2.0 or more, and the phrase “having antiviral properties” means that an antiviral activity value obtained by a test method according to ISO 21702:2019 is 2.0 or more.

The applicant has developed a method for producing an antireflective film (antireflective surface) having a moth-eye structure using an anodized porous alumina layer. By using the anodized porous alumina layer, a die having an inverted moth-eye structure can be produced with high mass productivity (see, Japanese Unexamined Patent Application Publication No. 2009-166502 and International Publications No. WO2011/125486 and No. WO2013/183576). The synthetic polymer films described in PTL 1 to PTL 4 and having on their surface a moth-eye structure having bactericidal activity can be produced by applying the above technique. The entire contents of Japanese Unexamined Patent Application Publication No. 2009-166502 and International Publications No. WO2011/125486 and No. WO2013/183576 are hereby incorporated herein by reference.

The method for producing a layered article including a synthetic polymer film having antimicrobial and/or antiviral properties according to the present disclosure includes: preparing a layered article including a substrate and a synthetic polymer film formed on the substrate, wherein the synthetic polymer film has, on a surface thereof, a plurality of protrusions having area equivalent circle diameters in a range of more than 20 nm to less than 500 nm when the surface is viewed in a direction normal to the synthetic polymer film; and irradiating the plurality of protrusions in the layered article with light emitted from a xenon lamp such that the amount of irradiation with light in a wavelength range of 300 nm or more to 400 nm or less is 6 MJ/m² or more. If the amount of irradiation is not 6 MJ/m² or more, the effect of improving the antimicrobial and/or antiviral properties may be insufficient. For example, the pH value cannot be reduced to 5.0 or less.

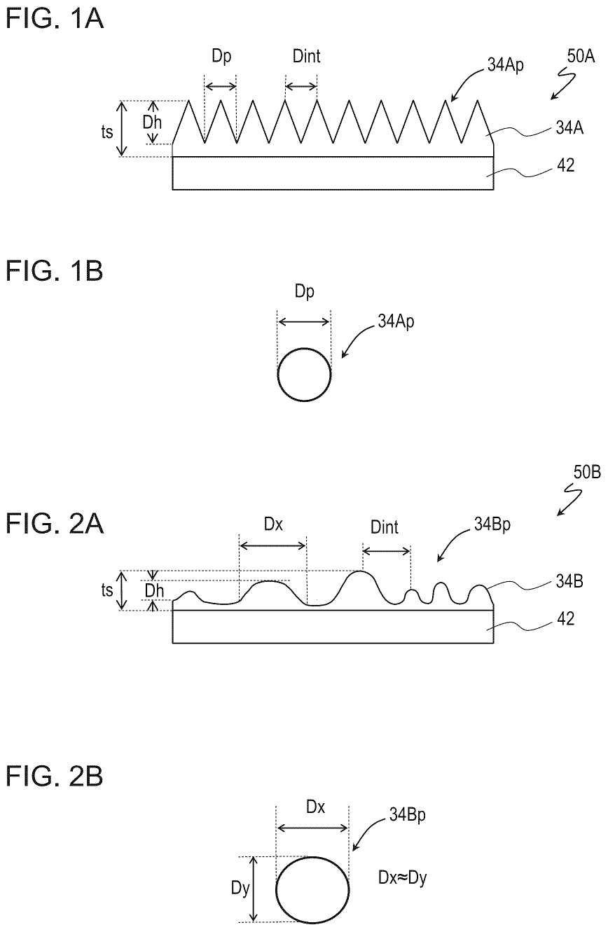

Referring first to FIGS. 1A and 1B, a description will be given of a layered article 50A including a substrate 42 and a synthetic polymer film 34A formed on the substrate 42. The synthetic polymer film 34A has, on a surface thereof, a plurality of protrusions 34Ap having area equivalent circle diameters in the range of more than 20 nm to less than 500 nm when the surface is viewed in a direction normal to the synthetic polymer film 34A.

The layered article 50A shown in FIG. 1A includes, for example, the substrate 42 and the synthetic polymer film 34A formed on the substrate 42. The synthetic polymer film 34A has the plurality of protrusions 34Ap on its surface, and the plurality of protrusions 34Ap form a moth-eye structure. When the synthetic polymer film 34A is viewed in a direction normal thereto, the two-dimensional size Dp of each protrusion 34Ap is within the range of more than 20 nm to less than 500 nm. The “two-dimensional size” of a protrusions 34Ap means the area equivalent circle diameter of the protrusion 34Ap when it is viewed in a direction normal to the surface. For example, when each protrusion 34Ap has a conical shape, the two-dimensional size of the protrusion 34Ap corresponds to the diameter of the bottom of the cone, as shown in FIG. 1B. The distance Dint between adjacent protrusions 34Ap is typically more than 20 nm and 1000 nm or less. As exemplified in FIG. 1A, the protrusions 34Ap are densely arranged. When no space is present between adjacent protrusions 34Ap (for example, the bottoms of cones partially overlap each other), the two-dimensional size Dp of each protrusion 34Ap is equal to the distance Dint between adjacent protrusions.

The height Dh of each protrusion 34Ap is typically 50 nm or more and less than 500 nm. The height Dh of each protrusion 34Ap may be 200 nm or less. The plurality of protrusions 34Ap include, for example, substantially conical protrusions each having a bottom with a diameter of more than 20 nm and less than 500 nm, and the substantially conical protrusions include protrusions whose heights are more than or equal to twice the diameters of their bottoms. The number of substantially conical protrusions whose heights are more than or equal to twice the diameters of their bottoms is, for example, 60% or more of the total number of protrusions. The plurality of protrusions 34Ap may not include the substantially conical protrusions whose heights are more than or equal to twice the diameters of their bottoms. In the present embodiment, the plurality of protrusions 34Ap do not include protrusions whose maximum bottom lengths are more than twice their heights and which are included in a plurality of protrusions 34Bp described later. No particular limitation is imposed on the thickness ts of the synthetic polymer film 34A so long as the thickness ts is larger than the height Dh of the protrusions 34Ap.

In the present specification, the term “moth-eye structure” is intended to encompass not only a surface nanostructure that includes protrusions having a shape whose cross-sectional area (the area of a cross section parallel to the film surface) increases toward the substrate 42, such as the protrusions 34Ap in the synthetic polymer film 34A shown in FIG. 1A, and that has a good antireflection function but also a surface nanostructure including protrusions having portions with constant cross-sectional areas (i.e., the areas of cross-sections parallel to the surface of the film are constant). To break the cell walls and/or cell membranes of bacteria, the protrusions may each have a conical portion. However, the conical portion may have a rounded apex.

The synthetic polymer film 34A having the moth-eye structure can be produced using a die having the inverted moth-eye structure described above. The synthetic polymer film 34A may be produced using a UV curable resin. The UV curable resin is cured when irradiated with ultraviolet rays from the so called “D bulb” (280 nm to 400 nm, peak wavelength: 380 nm). The UV curable resin used may be any of various known UV curable resins (such as acrylic resins). A resin obtained by irradiating a UV curable resin with UV rays may be referred to as a UV cured resin. The substrate 42 used may be, for example, any of various plastic films (such as polystyrene films, polyurethane films, aromatic polyamide films, polyester films, and polycarbonate films). Polycarbonate (PC) films having good lightfastness and oxidation resistance may be used.

The present inventors have found that the antimicrobial and/or antiviral properties can be improved by irradiating the plurality of protrusions 34Ap in the layered article with light emitted from the xenon lamp such that the amount of irradiation with light in the wavelength range of 300 nm or more to 400 nm or less is 6 MJ/m² or more. No particular upper limitation is imposed on the amount of irradiation. However, even if the amount of irradiation exceeds 22 MJ/m², the antimicrobial and/or antiviral properties are not further improved. From the viewpoint of mass productivity, the amount of irradiation is set to 22 MJ/m² or less. If the amount of irradiation exceeds 22 MJ/m², the synthetic polymer film may turn yellow in some cases. For example, when the irradiance of the light in the wavelength range of 300 nm or more to 400 nm or less is 60 W/m², the irradiation time may be set to 30 hours to 100 hours. For example, a xenon arc lamp (xenon whether meter XL75manufactured by Suga Test Instruments Co., Ltd.) is used to perform irradiation from a position 290 mm from the synthetic polymer film 34A. In this manner, the synthetic polymer film 34A can be irradiated with light whose irradiance in the wavelength range of 300 nm or more to 400 nm or less is about 60 W/m².

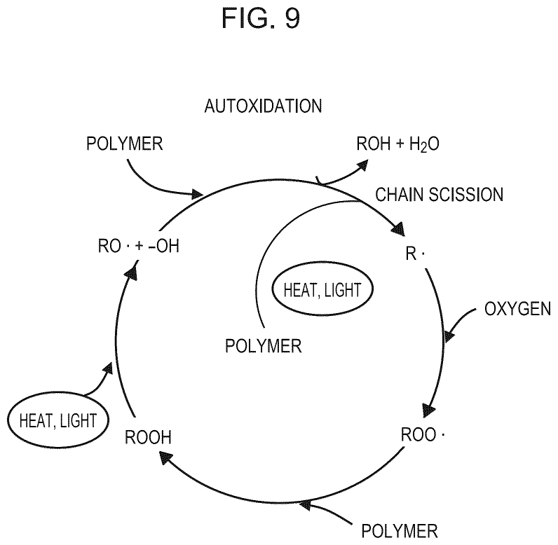

When the synthetic polymer film (which may be a UV cured resin) is irradiated with light in the wavelength range of 300 nm or more to 400 nm or less, chemical bonds included in the synthetic polymer film are broken, and well-known autoxidation occurs. Radicals and intermediates generated by photochemical reactions further undergo autoxidation, and radicals and acids are generated. The mechanism of the autoxidation is shown, for example, in FIG. 9. The radicals etc. generated attack proteins on the surfaces of bacteria and/or viruses to withdraw hydrogen, and the proteins are thereby decomposed. Moreover, the acids generated by the photochemical reactions can make it difficult for bacteria and/or viruses to survive. Organic components having aldehyde-based, carboxylic acid-based, and ester-based chemical structures are known to damage proteins such as DNA, RNA, and enzymes, and a UV cured resin film or substrate that generates such components through photochemical reactions may be used.

The irradiation with the light emitted from the xenon lamp may be performed in an environment at a relative humidity of 50% or less. This is because hydrolysis may occur in some UV curable resins. The irradiation with the light emitted from the xenon lamp may be performed while air is continuously blown onto the surface of the synthetic polymer film 34A. In this case. the synthetic polymer film 34A may be placed in an environment at about 50° C. or lower.

Referring next to FIGS. 2A and 2B, a description will be given of the structure of a layered article 50B including a synthetic polymer film 34B after irradiation with the light emitted from the xenon lamp. FIG. 2A is a schematic cross-sectional view of the layered article 50B including the synthetic polymer film 34B obtained by irradiating the synthetic polymer film 34A with the light emitted from the xenon lamp, and FIG. 2B is a schematic plan view showing a protrusion 34Bp viewed in a direction normal to the synthetic polymer film 34B.

As shown in FIG. 2A, the plurality of protrusions 34Bp included in the synthetic polymer film 34B are formed as a result of the decomposition of the plurality of protrusions 34Ap included in the synthetic polymer film 34A shown in FIG. 1A. Specifically, their heights Dh are lowered, and the apexes of the substantially conical protrusions are rounded.

Protrusions with flat apexes can also be formed. The bottoms of recesses between adjacent protrusions 34Bp are also rounded. Recesses having flat bottoms can also be formed between adjacent protrusions 34Bp. Variations in the shapes of the plurality of protrusions 34Bp and variations in their sizes increase. The plurality of protrusions 34Bp include protrusions each having a bottom whose maximum length (Dx in this case) is more than twice its height Dh. The plurality of protrusions 34Bp may include protrusions each having a bottom whose maximum length is more than or equal to three times its height Dh. The plurality of protrusions 34Bp may or may not include substantially conical protrusions whose heights are more than or equal to twice the diameters of their bottoms and which have been included in the plurality of protrusions 34Ap. The maximum length of the bottom of a protrusion is the maximum distance between two points on the outer circumference of the bottom of the protrusion.

As shown in FIG. 2B, when a protrusion 34Bp is viewed in a direction normal to the synthetic polymer film 34B, the maximum length (Dx in this case) of the bottom of the protrusion 34Bp is substantially the same as the minimum length of the bottom (the length Dy in a direction orthogonal to Dx in this case), and Dx/Dy is less than 2.0. The shape of the bottom of the protrusion 34Bp is substantially circular.

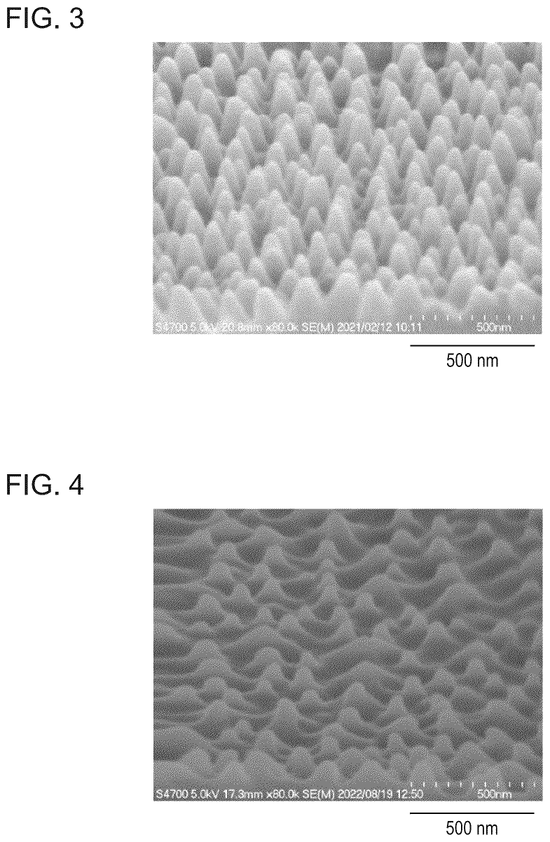

Referring to FIGS. 3 and 4, Experimental Examples will be described.

A synthetic polymer film having a moth-eye structure was formed on a polycarbonate base film. A (solvent-less) resin material was prepared by mixing polyethylene glycol diacrylate (M280 manufactured by MIWON SPECIALTY CHEMICAL CO., LTD.), trimethylolpropane triacrylate (M300 manufactured by MIWON SPECIALTY CHEMICAL CO., LTD.), 2-(2-vinyloxyethoxy) ethyl acrylate (VEEA manufactured by NIPPON SHOKUBAI Co., Ltd.), and 2-hydroxy-4′-(2-hydroxyethoxy)-2-methylpropiophenone (Omnirad 2959 manufactured by IGM Resins B.V.) used as a polymerization initiator at a mass ratio of M280:M300:VEEA:Omnirad=55:10:35:1. The prepared resin material was applied to the polycarbonate base film to a desired thickness and irradiated with light from a D bulb (320 to 400 nm, 1200 W/m²) for about 15 seconds (22500 J/m²). In the moth-eye structure, Dp=Dint =200 nm, and Dh=200 nm.

FIG. 3 shows an SEM image of the surface of the synthetic polymer film having the moth-eye structure. A plurality of substantially conical protrusions were found to be densely formed. The plurality of protrusions on the surface of the synthetic polymer film shown in FIG. 3 have the same features as those of the plurality of protrusions 34Ap described with reference to FIG. 1A and include substantially conical protrusions whose heights are more than or equal to twice the diameters of their bottoms. The ratio of the number of substantially conical protrusions whose heights are more than or equal to twice the diameters of their bottoms to the total number of protrusions is 60% or more. Substantially conical protrusions whose heights are less than twice the diameters of their bottoms are also present.

FIG. 4 shows an SEM image of the surface of a synthetic polymer film obtained by irradiating the above-described synthetic polymer film having the moth-eye structure with light (60 W/m²) emitted from a xenon lamp for 100 hours (about 22 MJ/m²). The protrusions in the moth-eye structure shown in FIG. 3 were found to be reduced in height due to decomposition. Some substantially conical protrusions are present, but the apexes of most of the protrusions are rounded. Protrusions with flat apexes are also found to be formed. The bottoms of recesses between adjacent protrusions are rounded, but some recesses between adjacent protrusions have flat bottoms. Variations in the shapes of the plurality of protrusions and variations in their sizes are found to be increased. In some protrusions, the maximum length of the bottom (which is the length in a substantially horizontal direction in this case and may be referred to as the “width”) is more than twice the height. However, the width is generally one to two times the height. In most of the protrusions, the width is 1.0 to 1.5 times the height. However, the plurality of protrusions may include protrusions each having a bottom whose maximum length is more than or equal to three times the height (for example, protrusions near the center in FIG. 4).

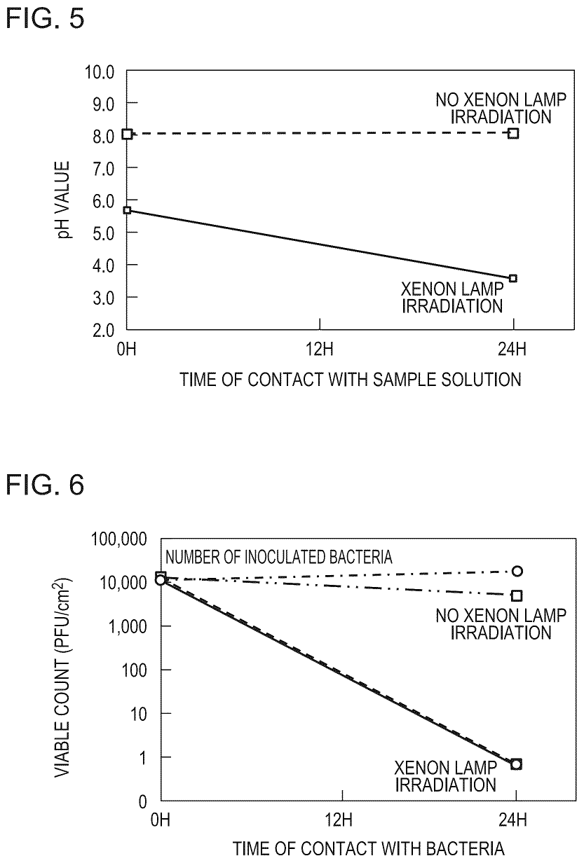

Next, reference is made to FIG. 5. FIG. 5 is a graph showing the change in pH over time with and without xenon lamp irradiation. Specifically, the change in pH over time was used to evaluate how the surface of the synthetic polymer film having the moth-eye structure was chemically changed by the xenon lamp irradiation. The horizontal axis of the graph represents the time of contact with a sample solution. The sample used was the synthetic polymer film shown in FIG. 4. The pH measurement was performed by a method corresponding to an antiviral property test. Specifically, the following method was used for the measurement.

0.1 mL of a diluted EMEM solution (a solution prepared by diluting an EMEM ten-fold with sterile distilled water), which is the same amount as the amount of a virus suspension, was added dropwise to the moth-eye structure surface of the sample disposed in a petri dish, and then a contact film (polyethylene film) was placed on the sample and gently pressed such that the diluted solution spread over the entire film. With this state maintained, a lid was placed on the petri dish, and the petri dish was left to stand at 25° C. for 24 H. Then the contact film was removed, and the pH of the sample solution on the surface of the sample was measured using a flat ISFET pH electrode manufactured by HORIBA Ltd.

As shown in FIG. 5, when the time of contact with the sample solution is 0 hours, the pH value (5.68) of the synthetic polymer film irradiated with the light from the xenon lamp is smaller than the pH value (8.05) of the synthetic polymer film unirradiated with the light from the xenon lamp and is in an acidic region. This may be because the xenon lamp irradiation caused photochemical reactions to occur on the surface of the synthetic polymer film and acid components were generated. When the time of contact with the sample solution is 24 hours, although the pH value (8.09) of the synthetic polymer film unirradiated with the light from the xenon lamp is almost unchanged, the pH value (3.60) of the synthetic polymer film irradiated with the light from the xenon lamp is further reduced. This may be because radicals and intermediates generated in the resin by the photochemical reactions undergo autoxidation reactions on the surface of the synthetic polymer film irradiated with the light from the xenon lamp.

FIG. 6 shows the results of the evaluation of antimicrobial properties by a method in accordance with JIS Z 2801 (ISO 22196). A bacterial suspension was inoculated into each of a sample irradiated with the light from the xenon lamp and a sample unirradiated with the light from the xenon lamp, and the samples were allowed to contact the bacteria for 24 hours. Then the number of bacteria on each sample was measured by a plaque assay, and the antimicrobial activity value was computed by comparing the number of bacteria in the sample irradiated with the light from the xenon lamp with that in the sample unirradiated with the light from the xenon lamp.

The strains used were Staphylococcus aureus (a dash-dot line and a solid line in FIG. 6) and Escherichia coli (a dash-double-dot line and a broken line in FIG. 6). Although the moth-eye structure unirradiated with the light from the xenon lamp did not exhibit the antimicrobial effect against these types of bacteria, the antimicrobial activity value of the synthetic polymer film irradiated with the light from the xenon lamp and having the moth-eye structure was more than 2.0 for both the strains. It can be seen that the xenon lamp irradiation can improve the antimicrobial properties. The antimicrobial activity value was determined as follow.

Antimicrobial activity value=log (number of bacteria in untreated sample after 24 hours of cultivation)−log (number of bacteria in antimicrobial-treated sample after 24 hours of cultivation)

Staphylococcus aureus: Activity value≥4.4=4.25−(−0.2)

Escherichia coli: Activity value≥3.9=3.7−(−0.2)

“−0.2” means the detection limit.

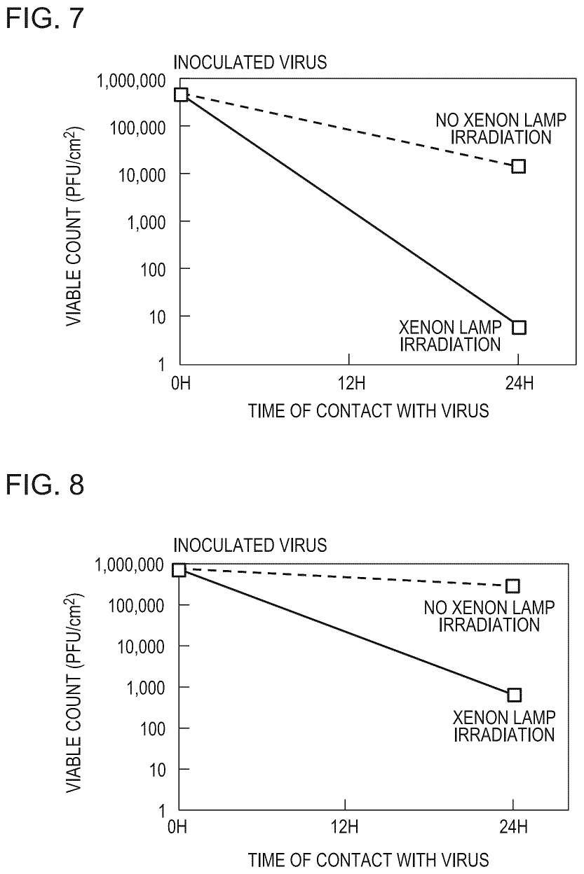

FIGS. 7 and 8 show the results of evaluation of antiviral properties by a method in accordance with ISO 21702:2019.

The viruses used were influenza virus A (enveloped virus) (FIG. 7) and feline calicivirus (non-enveloped virus) (FIG. 8).

As can be seen from FIGS. 7 and 8, the xenon lamp irradiation improves the antivirus effect, and the antiviral activity value was more than 2.0 for both the viruses. The antiviral activity value was determined as follows.

Antiviral activity value=log (virus count in untreated sample after 24 hours of cultivation)−log (virus count in antivirus-treated sample after 24 hours of cultivation)

Anti-influenza activity value≥3.4=4.16−0.8

Anti-feline calicivirus activity value≥2.7=5.49−2.83

In the above examples, the synthetic polymer film having the moth-eye structure was irradiated with light from the xenon lamp. However, even when a synthetic polymer film having no moth-eye structure is formed using a resin material that undergoes chemical reactions such as autoxidation when irradiated with light from a xenon lamp, decomposes, and forms a fine irregular structure on the surface of the film, the antimicrobial and/or antiviral properties may be improved. The conditions for xenon lamp irradiation can be the same as those for the synthetic polymer film having the moth-eye structure shown above.

The method for producing the layered article including the synthetic polymer film having antimicrobial and/or antiviral properties in the embodiment of the present disclosure allows the layered article having improved antimicrobial and/or antiviral properties to be provided.

According to the embodiment of the present disclosure, the layered article including the synthetic polymer film can have antiviral properties for both enveloped and non-enveloped viruses.

Embodiments of the present disclosure provide solutions described in the following items.

### [Item 1]

A method for producing a layered article including a synthetic polymer film having antimicrobial and/or antiviral properties, the method including:
preparing a layered article including a substrate and a synthetic polymer film formed on the substrate, wherein the synthetic polymer film has, on a surface thereof, a plurality of protrusions having area equivalent circle diameters in a range of more than 20 nm to less than 500 nm when the surface is viewed in a direction normal to the synthetic polymer film; and
irradiating the plurality of protrusions in the layered article with light emitted from a xenon lamp such that the amount of irradiation with light in a wavelength range of 300 nm or more to 400 nm or less is 6 MJ/m² or more.

### [Item 2]

The method for producing according to Item 1, wherein the irradiating with the light from the xenon lamp is performed such that the amount of irradiation with the light in the wavelength range of 300 nm or more to 400 nm or less is 22 MJ/m² or less.

### [Item 3]

The method for producing according to claim 1 or 2, wherein the irradiating with the light from the xenon lamp is performed in an environment at a relative humidity of 50% or less.

### [Item 4]

The method for producing according to any one of Items 1 to 3, wherein the irradiating with the light from the xenon lamp is performed while air is continuously blown onto the surface of the synthetic polymer film.

### [Item 5]

The method for producing according to any one of Items 1 to 4, wherein the synthetic polymer film is formed of a UV cured resin.

### [Item 6]

The method for producing according to Item 5, further including, before the irradiating with the light from the xenon lamp, irradiating a UV curable resin with UV rays to form the UV cured resin forming the synthetic polymer film.

### [Item 7]

The method for producing according to any one of Items 1 to 6, wherein the plurality of protrusions include substantially conical protrusions each having a bottom with a diameter of more than 20 nm and less than 500 nm.

### [Item 8]

The method for producing according to Item 7, wherein the substantially conical protrusions include protrusions whose heights are more than or equal to twice the diameters of the bottoms thereof.

### [Item 9]

A layered article including a synthetic polymer film having antimicrobial and/or antiviral properties and produced by the method for producing according to any one of Items 1 to 8.

### [Item 10]

The layered article according to Item 9, wherein the synthetic polymer film has, on the surface thereof, a plurality of protrusions having area equivalent circle diameters in the range of more than 20 nm to less than 500 nm when the surface is viewed in the direction normal to the synthetic polymer film, and
wherein the plurality of protrusions include protrusions each having a bottom whose maximum length is more than twice the height thereof.

The present disclosure contains subject matter related to that disclosed in Japanese Priority Patent Application JP 2023-212708 filed in the Japan Patent Office on Dec. 18, 2023, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A method for producing a layered article including a synthetic polymer film having antimicrobial and/or antiviral properties, the method comprising:
preparing a layered article including a substrate and a synthetic polymer film formed on the substrate, wherein the synthetic polymer film has, on a surface thereof, a plurality of protrusions having area equivalent circle diameters in a range of more than 20 nm to less than 500 nm when the surface is viewed in a direction normal to the synthetic polymer film; and
irradiating the plurality of protrusions in the layered article with light emitted from a xenon lamp such that the amount of irradiation with light in a wavelength range of 300 nm or more to 400 nm or less is 6 MJ/m² or more.

2. The method for producing according to claim 1, wherein the irradiating with the light from the xenon lamp is performed such that the amount of irradiation with the light in the wavelength range of 300 nm or more to 400 nm or less is 22 MJ/m² or less.

3. The method for producing according to claim 1, wherein the irradiating with the light from the xenon lamp is performed in an environment at a relative humidity of 50% or less.

4. The method for producing according to claim 1, wherein the irradiating with the light from the xenon lamp is performed while air is continuously blown onto the surface of the synthetic polymer film.

5. The method for producing according to claim 1, wherein the synthetic polymer film is formed of a UV cured resin.

6. The method for producing according to claim 5, further comprising, before the irradiating with the light from the xenon lamp, irradiating a UV curable resin with UV rays to form the UV cured resin forming the synthetic polymer film.

7. The method for producing according to claim 1, wherein the plurality of protrusions include substantially conical protrusions each having a bottom with a diameter of more than 20 nm and less than 500 nm.

8. The method for producing according to claim 7, wherein the substantially conical protrusions include protrusions whose heights are more than or equal to twice the diameters of the bottoms thereof.

9. A layered article comprising a synthetic polymer film having antimicrobial and/or antiviral properties and produced by the method for producing according to claim 1.

10. The layered article according to claim 9, wherein the synthetic polymer film has, on the surface thereof, a plurality of protrusions having area equivalent circle diameters in the range of more than 20 nm to less than 500 nm when the surface is viewed in the direction normal to the synthetic polymer film, and
wherein the plurality of protrusions include protrusions each having a bottom whose maximum length is more than twice the height thereof.
